(19) United States
(12) Patent Application Publication
(10) Pub. No.: US 2026/0007911 A1
(43) Pub. Date: Jan. 8, 2026

(54) Portable Fall Protection System for Railcars

(71) Applicant: Cole Mark Bellefeuille, Moose Jaw (CA)

(72) Inventor: Cole Mark Bellefeuille, Moose Jaw (CA)

(21) Appl. No.: 19/133,606

(22) PCT Filed: Dec. 6, 2023
(86) PCT No.: PCT/CA2023/051613

§ 371 Date: May 28, 2025

Related U.S. Application Data
(60) Provisional application No. 63/432,159, filed on Dec. 13, 2022.

(51) Int. Cl. A62B 35/00; B61K 13/00

(52) U.S. Cl. CPC A62B 35/0056; A62B 35/0068; B61K 13/00

(57) ABSTRACT

A portable fall protection system for use with a railcar, having draw bar adapters removably attachable to the fore and aft draw bars of the railcar, and masts removably mountable on the draw bar adapters, such that the masts extend above the upper surface of the railcar when mounted, and a cable for extending between upper ends of the masts to receive a user connection member connecting the user to the cable to allow the user to walk along the upper surface of the railcar. A winch and a weight indicator may be provided at the ends of the cable to tension the cable. Additional tensioning cables are provided for securing the masts to the rails in front of and behind the railcar.

### TECHNICAL FIELD OF THE INVENTION

The present invention relates to fall support and fall arrest systems for workers accessing upper surfaces of railcars.

### BACKGROUND OF THE INVENTION

It is known in the art of railcar handling and maintenance that workers must access upper surfaces of the railcars from time to time, for example to engage in loading, unloading, cleaning, repairs and/or inspection. As such upper surfaces require the workers to be engaged in their activities at height, and such surfaces may be wet or icy, this represents a significant risk of serious injury or death in the event of a fall where safety measures are not in place.

To address this risk to workers, various prior art systems have been proposed. For example, some prior art systems are constructed beside the rails and extend over where the railcar will be positioned, and they comprise a cable or metal beam running a distance generally equal to the length of a railcar at a height above where the upper surface will be. When the railcar has been moved into place beside such a prior art system, the worker can then ascend to the upper surface of the railcar and connect a safety line such as a lanyard between their body and the cable or beam, thus allowing the worker to move across the railcar upper surface.

However, such prior art systems are commonly permanent and require the railcars to be moved precisely into position beside them. This reduces the utility of such systems, both in terms of where they can be accessed but also limiting their use given that railcars must be moved into position one at a time.

What is needed, therefore, is a safety system with flexible deployment that is not tied to a single permanent location.

### SUMMARY OF THE INVENTION

According to a first broad aspect of the present invention, there is provided a portable fall protection system for use with a railcar, the railcar comprising an upper surface and first and second draw bars at opposite ends of the railcar, the railcar situated on rails, the system comprising:
first and second draw bar adapters removably attachable to the first and second draw bars, respectively;
first and second masts removably mountable on the first and second draw bar adapters, respectively, the first and second masts extending above the upper surface of the railcar when mounted on the first and second draw bar adapters; and
a cable configured for extension between upper ends of the first and second masts, the cable configured for receipt of a user connection member connecting the user to the cable to allow the user to walk along the upper surface of the railcar.

Some exemplary systems further comprise a winch on the first mast and a weight indicator on the second mast, the cable extending between the winch and the weight indicator through pulleys on top of each of the first and second masts, allowing tensioning of the cable. Exemplary systems may further comprise at least one tensioning cable for removable connection between each of the first and second masts and the rails to further stabilize the system.

Each of the first and second masts may comprise a plurality of sections configured for assembly on the railcar, allowing for ease of transport and installation.

In some exemplary systems, first and second bracket members are provided, each of the first and second bracket members configured for securing to the first and second masts, respectively, and resting on the upper surface of the railcar, thus further stabilizing the system.

In some exemplary embodiments, the first and second masts comprise first and second segments; the first segments of the first and second masts vertically mountable on the first and second draw bar adapters, respectively; and the first segments configured to raise and lower the second segments; such that the second segments can be raised in horizontal orientation and then rotated to vertical allowing the cable to extend between upper ends of the second segments. In some such embodiments, each of the first and second draw bar adapters comprises an aperture configured for receiving a lower end of the second segment. Each of the first segments may comprise a winch for raising and lowering the second segment, and in some such embodiments each of the first segments is provided with a sliding member for rotatably retaining the second segment, the sliding member vertically displaceable by means of the winch.

In some exemplary embodiments the upper ends of the second segments comprise the first and second bracket members, the second segments rotatable from horizontal to vertical to allow the first and second bracket members to clear the upper surface of the railcar during rotation, and the first and second bracket members configured for the resting on the upper surface when the second segments are lowered into the apertures. The first and second bracket members may be further rotatable to a first position on the second segments so as to avoid contact with the upper surface of the railcar during rotation, the first and second bracket members rotatable to a second position after the first and second bracket members have cleared the upper surface to enable the first and second bracket members to rest on the upper surface.

Some exemplary embodiments comprising the first and second segments further comprise at least one tensioning cable for removable connection between each of the first segments and the rails.

A detailed description of exemplary embodiments of the present invention is given in the following. It is to be understood, however, that the invention is not to be construed as being limited to these embodiments. The exemplary embodiments are directed to particular applications of the present invention, while it will be clear to those skilled in the art that the present invention has applicability beyond the exemplary embodiments set forth herein.

### BRIEF DESCRIPTION OF THE DRAWINGS

In the accompanying drawings, which illustrate exemplary embodiments of the present invention:

FIG. 1 is a side elevation view of an exemplary embodiment of the present invention, installed on a railcar on rails.

FIGS. 2a, 2b, 2c and 2d are, respectively, left side elevation, front elevation, right side elevation and perspective views of a second (anchor side) mast according to an exemplary embodiment of the present invention.

FIGS. 3a, 3b, 3c and 3d are, respectively, left side elevation, front elevation, right side elevation and perspective views of a first (winch side) mast according to an exemplary embodiment of the present invention.

FIG. 4a is a perspective view of a second mast adapter segment according to an exemplary embodiment of the present invention.

FIG. 4b is a perspective view of a first mast adapter segment according to an exemplary embodiment of the present invention.

FIG. 4c is a perspective view of a draw bar adapter installed on a draw bar according to an exemplary embodiment of the present invention.

FIG. 5 is a perspective view of anchor side cable component details according to an exemplary embodiment of the present invention.

FIG. 6a is a perspective view of a first mast installed on a railcar with tensioning cables connecting to the rails according to an exemplary embodiment of the present invention.

FIG. 6b is a perspective view of a two-part rail block for connecting tensioning cables to rails according to an exemplary embodiment of the present invention.

FIG. 7 is a perspective view of a second mast with cable and tensioning cables according to an exemplary embodiment of the present invention.

FIG. 8a to 8f illustrates a mast embodiment where an upper segment is raised horizontally and then rotated into position at height.

FIG. 9 illustrates an embodiment where the box rotates away from the railcar to avoid contact with any upper surface extension.

FIG. 10a to 10d illustrates an embodiment where the mast comprises an upper segment raised by means of a winch on a lower mast segment.

FIG. 11a to 11d illustrates details of a slide by which the upper mast segment of FIG. 10a is vertically moveable on the lower mast segment.

FIG. 12a to 12d illustrates a pivot bracket by which the upper mast segment of FIG. 10a is pivotable relative to the lower mast segment.

FIG. 13a to 13d illustrates a draw bar adapter for use with the embodiments of FIG. 10a to 12d.

Exemplary embodiments will now be described with reference to the accompanying drawings.

### DETAILED DESCRIPTION OF EXEMPLARY EMBODIMENTS

Throughout the following description, specific details are set forth in order to provide a more thorough understanding to persons skilled in the art. However, well known elements may not have been shown or described in detail to avoid unnecessarily obscuring the disclosure. The following description of examples of the invention is not intended to be exhaustive or to limit the invention to the precise form of any exemplary embodiment. Accordingly, the description and drawings are to be regarded in an illustrative, rather than a restrictive, sense.

The present invention is directed to a system for providing fall protection for workers accessing a railcar upper surface, specifically where the system comprises masts installed on the railcar draw bars, with optional further stabilizing features such as bracket members between the masts and the upper surface and tensioning cables connecting the masts to the rails.

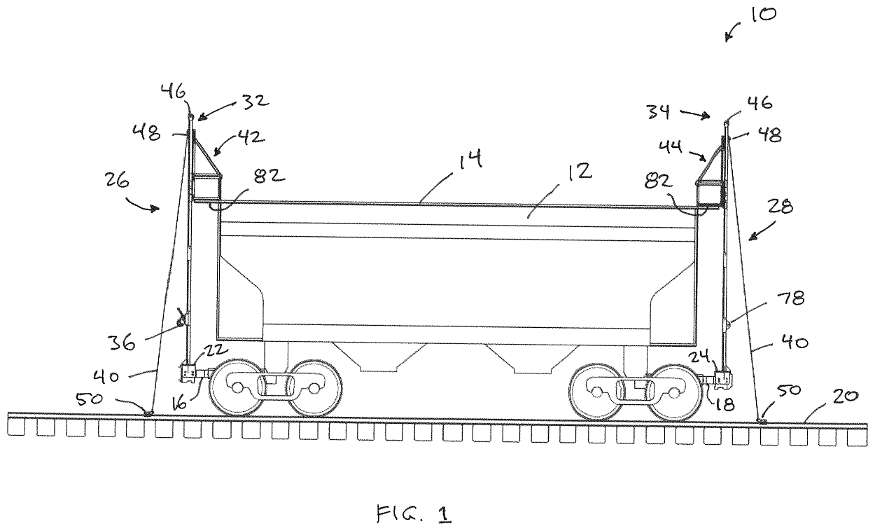

Turning now to the drawings, FIG. 1 illustrates an exemplary fall protection system 10. The system 10 is configured for mounting on a railcar 12 with further securing to the rails 20 as described below. The railcar 12 has an upper surface 14 which workers would need to access, thus placing themselves at risk of a fall from height. The railcar 12 further has first and second draw bars 16, 18, positioned at opposite ends of the railcar 12 and conventionally including pre-cut holes for connection to end-of-train devices.

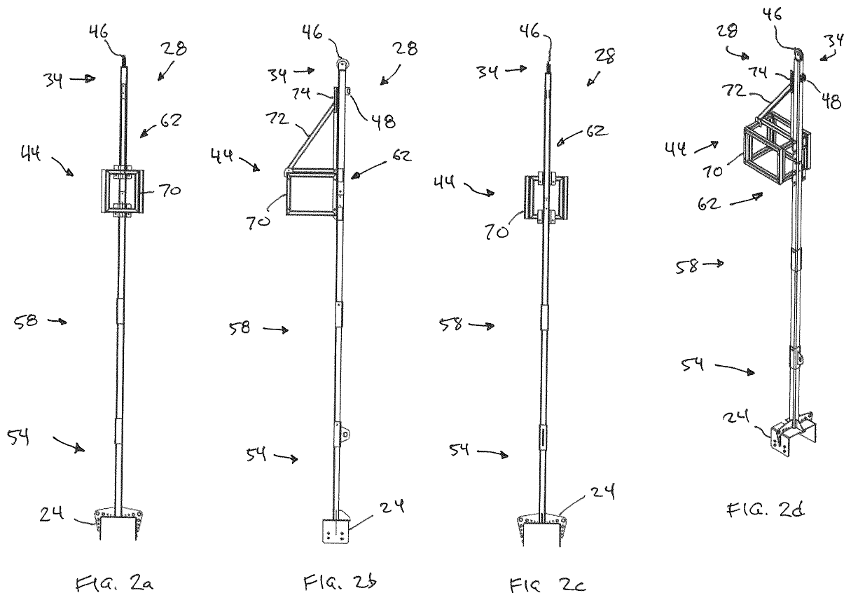

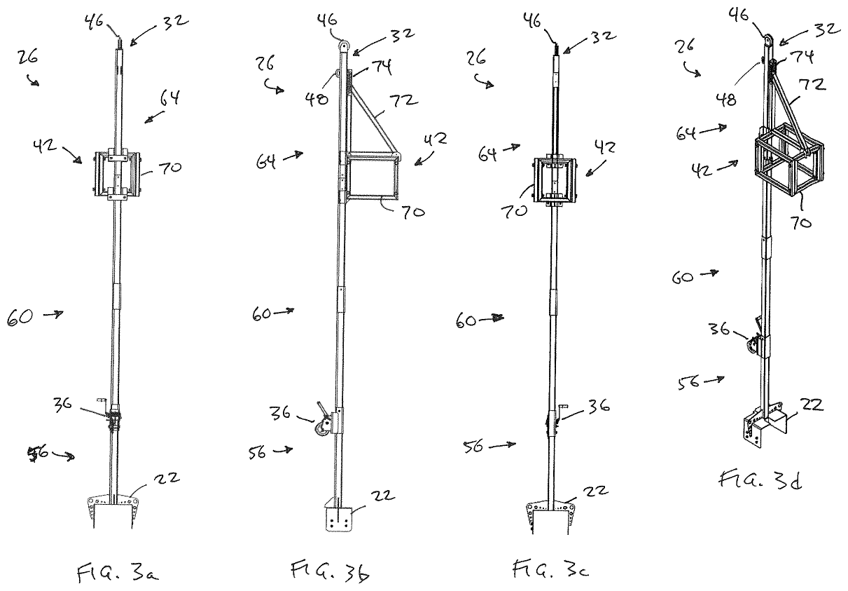

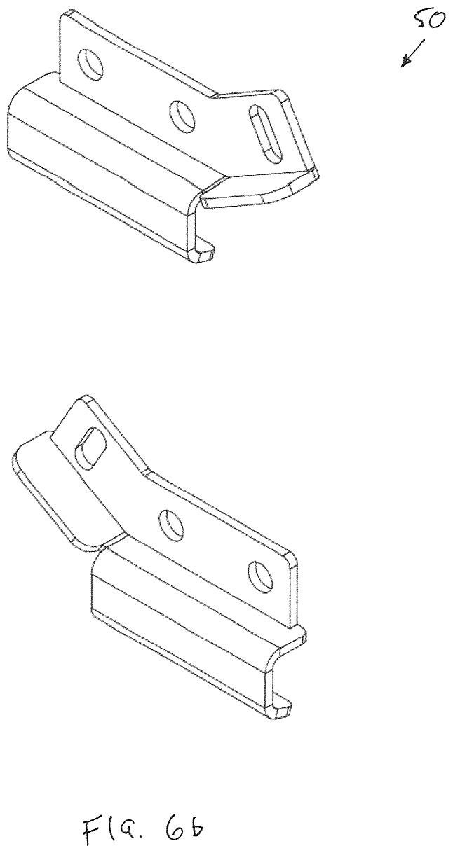

The system 10 comprises first and second masts 26, 28, which are configured for mounting to the first and second draw bars 16, 18, with upper ends 32, 26 of the masts 26, 28 for supporting a cable 30 (shown in FIG. 7) therebetween—it is the cable 30 to which a worker would connect their lanyard or other safety line. The masts 26, 28 are preferably but not necessarily composed of aluminum, and those skilled in the art will be able to easily determine suitable alternative materials. The mounting of the masts 26, 28 is achieved by the use of first and second draw bar adapters 22, 24, as shown in FIG. 2a to 4c. Each of the adapters 22, 24 comprise holes in the sides to align with the pre-existing holes in the draw bars 16, 18, and bolts 52 are inserted into the holes to secure the adapters 22, 24 to the draw bars 16, 18, respectively, leaving a vertical square tubing section disposed upwardly.

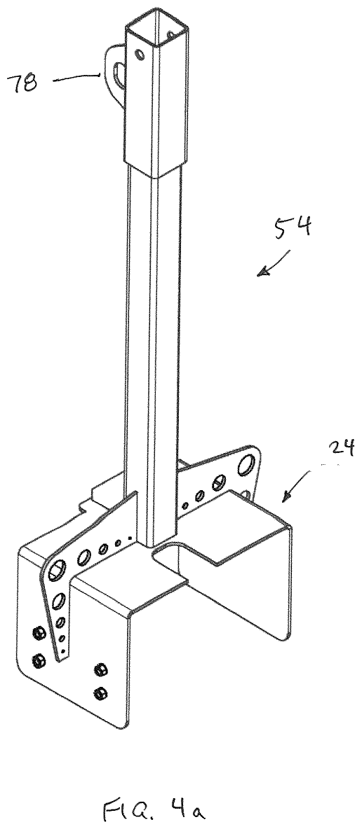

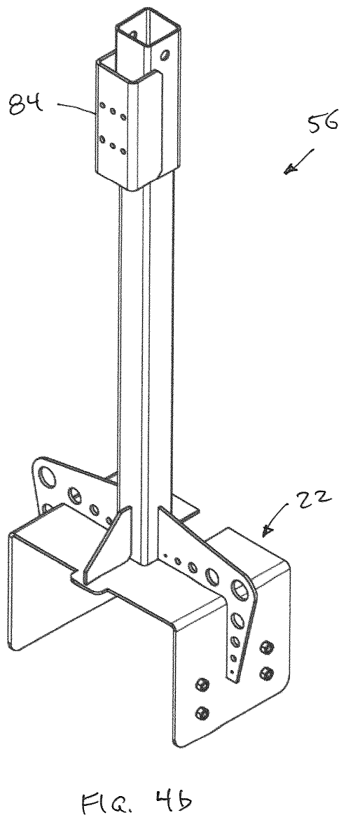

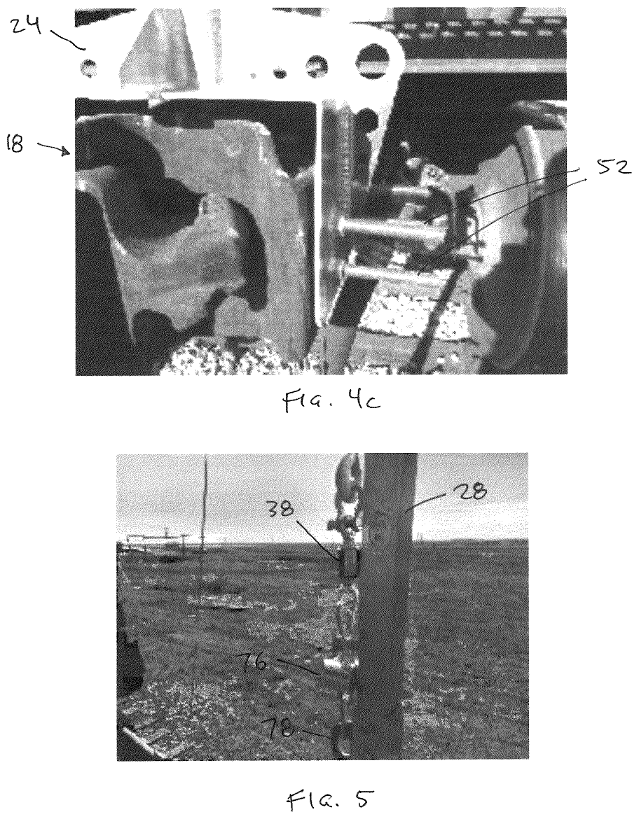

The exemplary masts 26, 28 are composed of connectable sections, although they may alternatively be of unitary construction. As can best be seen in FIG. 2a to 2d, the second mast 28 (which is mounted on the right side of the railcar 12 in FIG. 1) comprises a lower adapter segment 54 (shown in detail in FIG. 4a), a middle segment 58, and atop segment 62. The top segment 62 is provided with a pulley 46 for supporting the cable 30 when the system is assembled. Likewise, as can be seen in FIG. 3a to 3d, the first mast 26 (which is mounted on the left side of the railcar 12 in FIG. 1) comprises a lower adapter segment 56 (shown in detail in FIG. 4b), a middle segment 60, and a top segment 64, the top segment 64 provided with a pulley 46 for supporting the cable 30 when the system is assembled. The various sections of the masts 26, 28 can be connected by any suitable means including connector sleeves and Grade 8 bolts 52.

To further enhance stability of the exemplary system 10, the masts 26, 28 are provided with first and second bracket members 42, 44, respectively, shown particularly in FIGS. 1, 2d, 3d, 6a and 7. Each of the bracket members 42, 44 comprises a box 70 which is secured to the mast 26, 28 at two points (see FIGS. 2a to 2d and 3a to 3d) and a diagonal support arm 72 between the box 70 and the mast 26, 28. The diagonal support arm 72 is attached to the mast 26, 28 at an attachment member 74 that is provided with multiple holes to address differing heights. The box 70 on each side of the railcar is mounted to the mast 26, 28 but only rests on the upper surface 14 or extensions 82 thereof. The box 70 and diagonal support arm 72 are preferably composed of square aluminum tubing, but those skilled in the art will easily be able to determine alternative materials suitable for specific applications.

The cable 30 is supported by the pulleys 46 on the upper ends 32, 34 of the masts 26, 28, but also subject to tensioning to help ensure fall protection for workers. One end of the cable 30 is wound onto a winch 36 mounted on the first mast 26, which winch 36 can best be seen in FIGS. 1, 3a to 3d and 6a. The winch 36 is connected to the first mast 26 by means of a mounting plate 84 (as is shown in FIG. 4b). The cable 30 can then be passed across the pulleys 46 and down the second mast 28 for securing. As can best be seen in FIG. 5, the cable 30 is connected at its end to a weight indicator 38 (for use in determining weight applied) and the weight indicator 38 is in turn connected to an energy absorber or deceleration device 76 such as the commercially available 3M™ DBI-SALA® Zorbit™ device. The energy absorber 76 is then secured to an anchor point 78 on the second mast 28 (see FIGS. 4a and 5). It is believed that the weight indicator 38 and energy absorber 76 being connected in series and secured to the anchor point 78 may help to limit the arresting force on the worker should they fall from the upper surface 14 of the railcar 12. The winch 36 can then be wound to tighten the cable 30 to a predetermined pound level. It is to be noted, however, that a weight indicator is an optional feature of systems according to the present invention.

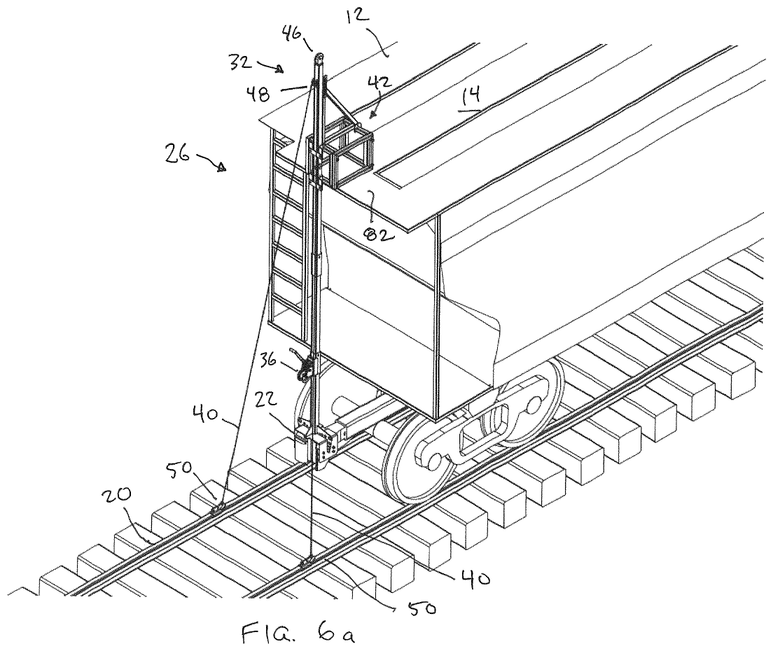

Once the cable 30 has been tensioned as desired for the specific application and applicable regulations for fall support systems, additional stabilizing can be achieved by tie-back tensioning cables 40. Turning to FIGS. 1, 6a and 6b, tensioning cables 40 are shown for securing the masts 26, 28 to the rails 20. The upper ends of the tensioning cables 40 are secured to the masts 26, 28 at anchor points 48 high on the masts 26, 28. Extending downwardly and away from the railcar 12, the tensioning cables 40 are connected at their lower ends to rail blocks 50 which are composed of two parts connected by bolts so they are secured around the rails 20. Alternatively, the tensioning cables 40 may be connected to the rail blocks 50 by means of turnbuckles (not shown). This further stabilizes the system 10 and thus is believed to enhance worker safety.

FIG. 7 illustrates the cable 30 passing over the pulley 46 and downwardly along the mast 28, and two tensioning cables 40 connected to the anchor point 48.

Once the cable 30 has been tensioned as described above and the tensioning cables 40 are secured to the rails 20, the system 10 is ready for engagement by the worker. The worker may ascend the railcar 12 to stand on the upper surface 14 and attach their lanyard or other safety line to the cable 30 which is strung and tensioned between the upper ends 32, 34 of the masts 26, 28.

The cable 30 is preferably 5/16 inch steel cable. The tensioning cables 40 are also preferably 5/16 inch steel cable. However, those skilled in the art will be readily capable of selecting alternative cable materials and sizes according to the specific application. All bolts are Grade 8 bolts, but those skilled in the art will be readily capable of selecting alternative bolt types and sizes according to the specific application.

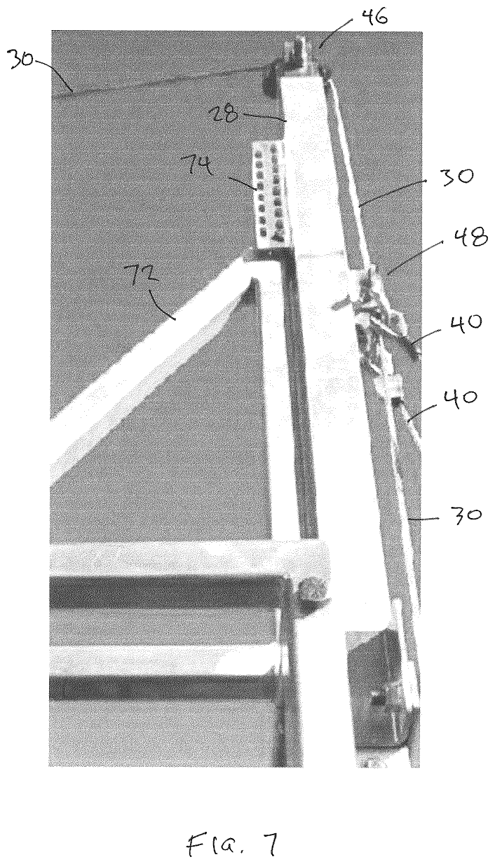

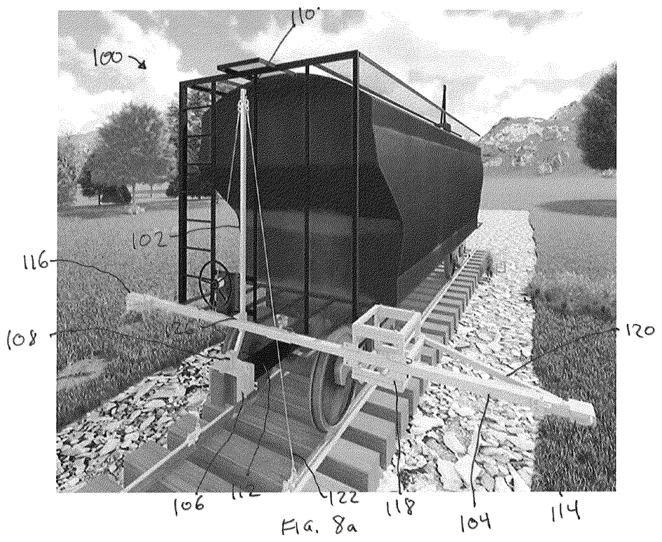

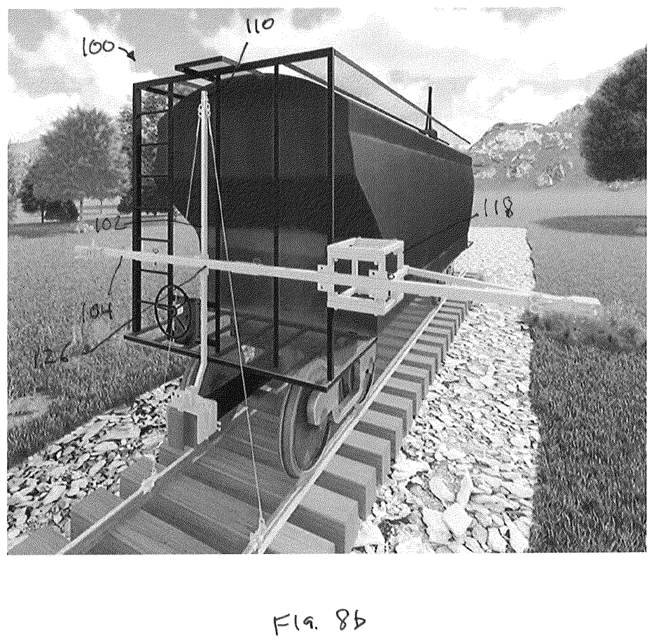

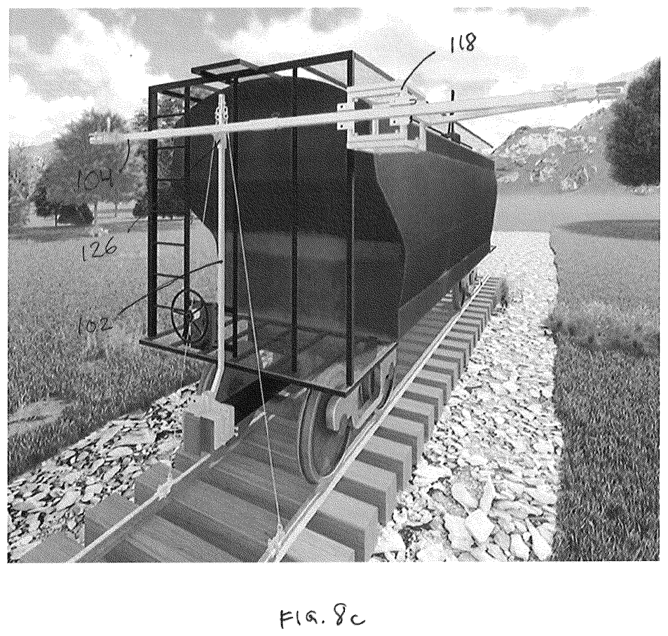

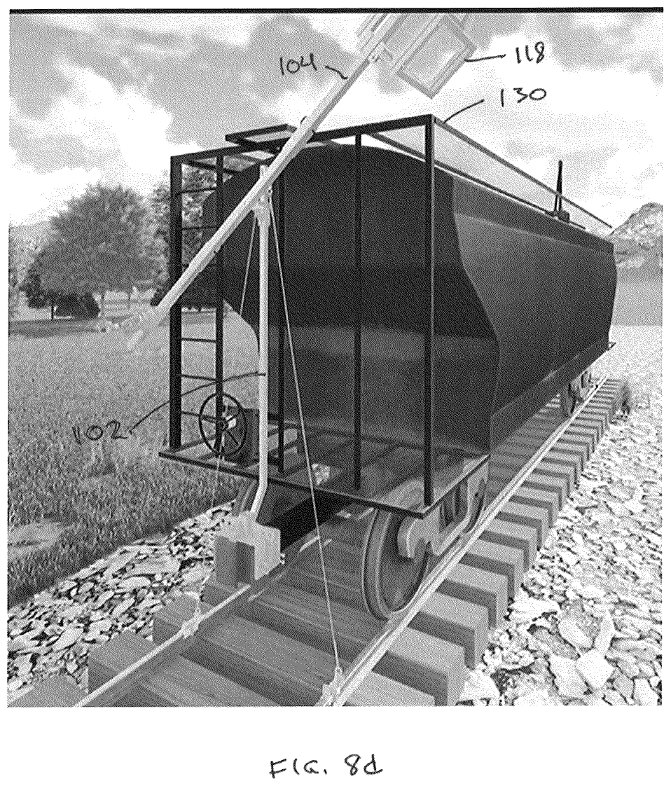

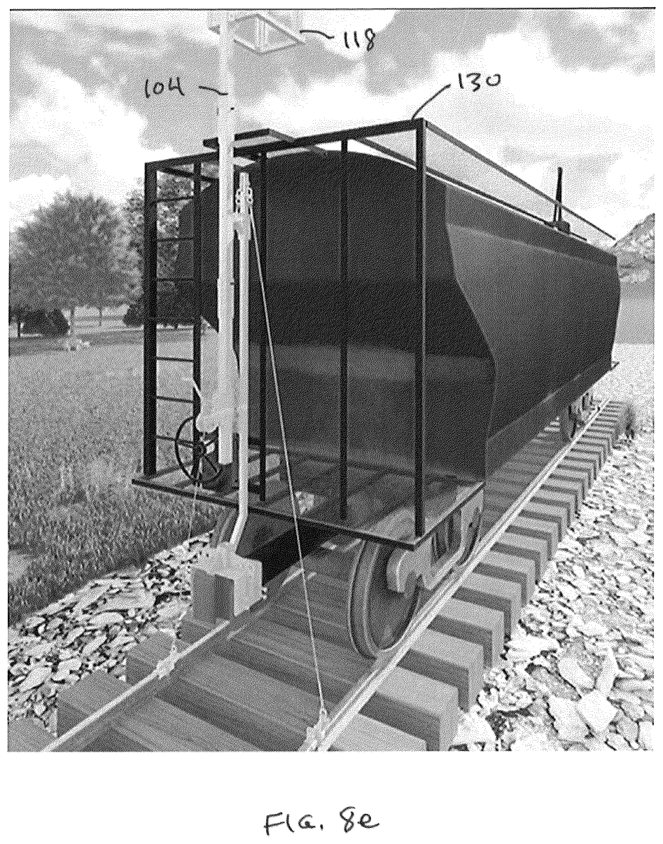

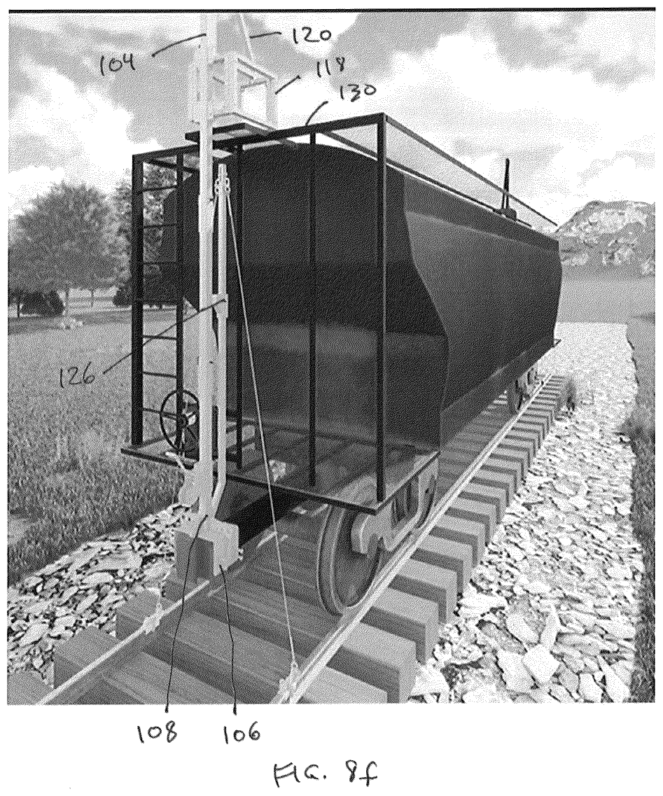

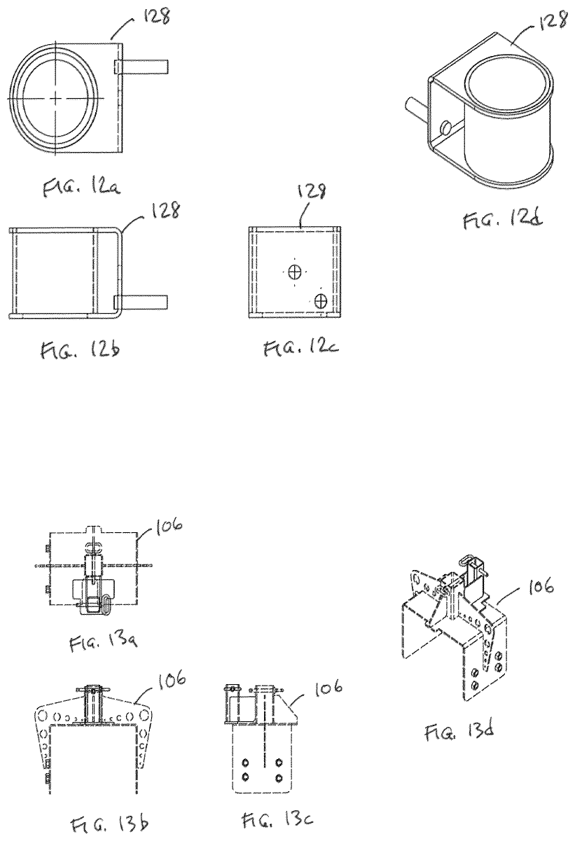

Turning now to FIG. 8a to 8f, a further exemplary embodiment of the present invention is illustrated, namely system 100. Unlike system 10 in which the masts 26, 28 are of unitary construction or assembled from connectable sections, the system 100 comprises first mast segments 102 which are used to raise second mast segments 104 at each end of the railcar and thus reduce the potential need for workers to access the railcar upper surface in order to mount and/or assemble mast sections. As can be seen in FIG. 8a, a draw bar adapter 106 is mounted on a draw bar as described above (illustrated in detail in FIG. 13a to 13d). The first mast segment 102 is mounted on the draw bar adapter 106 at a lower end 112 and extends vertically with its upper end 110 positioned just below the upper surface of the railcar. Tensioning cables 122 connect the upper end 110 to the rails in the illustrated embodiment, but this is an optional feature that may not be required in all embodiments of the present invention. The second mast segment 104 is slidably connected to the first mast segment 102 by means of a slide 126 (shown in greater detail in FIGS. 10a and 11a to 11d) and disposed horizontally for raising and lowering, the second mast segment 104 comprising a lower end 116 configured for receipt in an aperture 108 in the draw bar adapter 106 and an upper end 114. FIG. Sa illustrates the first stage in the positioning of the second mast segment 104, in which the second mast segment 104 and slide 126 are positioned near the bottom of the first mast segment 102. As with the masts 26, 28 described above, the second segments 104 each support a box 118 and a diagonal support arm 120.

FIG. 8b illustrates a second stage in the positioning of the second mast segment 104, in which the slide 126 is moved vertically upwardly along the first mast segment 102 to thereby begin raising the horizontally-disposed second mast segment 104. While not shown in FIG. 8a to 8f, the exemplary embodiment preferably employs a winch 124 (shown in FIG. 10a to 10d) mounted on the first mast segment 102 to raise and lower the slide 126.

At the stage illustrated in FIG. 8c, the second mast segment 104 has been raised to the upper end 110 of the first mast segment 102, still horizontally disposed. It is at this point that the second mast segment 104 can be rotated. FIG. 8d illustrates the second mast segment 104 partially rotated, the box 118 clearing the extension 130 of the upper surface due to the length of the second mast segment 104. In FIG. 8e, the second mast segment 104 has been rotated to vertical, but the box 118 is too high to rest on the upper surface of the railcar. The final stage, illustrated in FIG. 8f, is then to again use the winch 124 to now lower the slide 126 and the second mast segment 104 so that the lower end 116 of the second mast segment 104 can mate with the aperture 108 in the draw bar adapter 106, allowing the box 118 to rest on the upper surface or extensions 130 thereof.

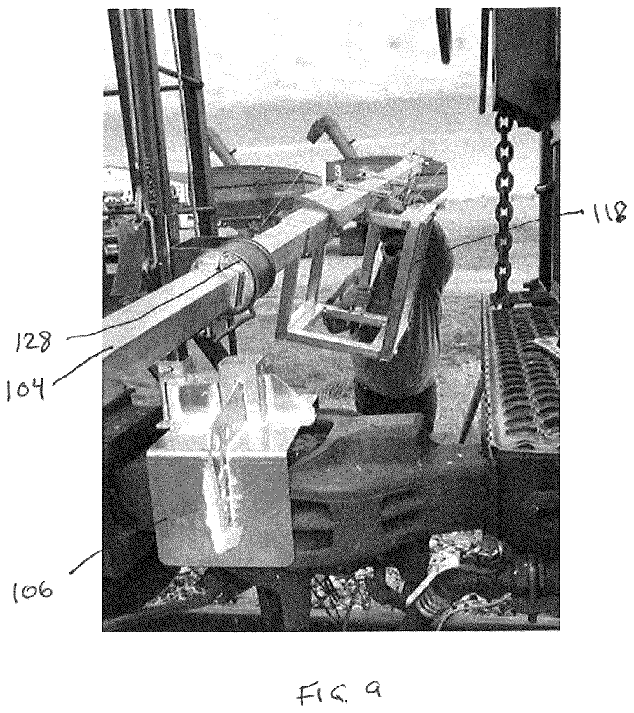

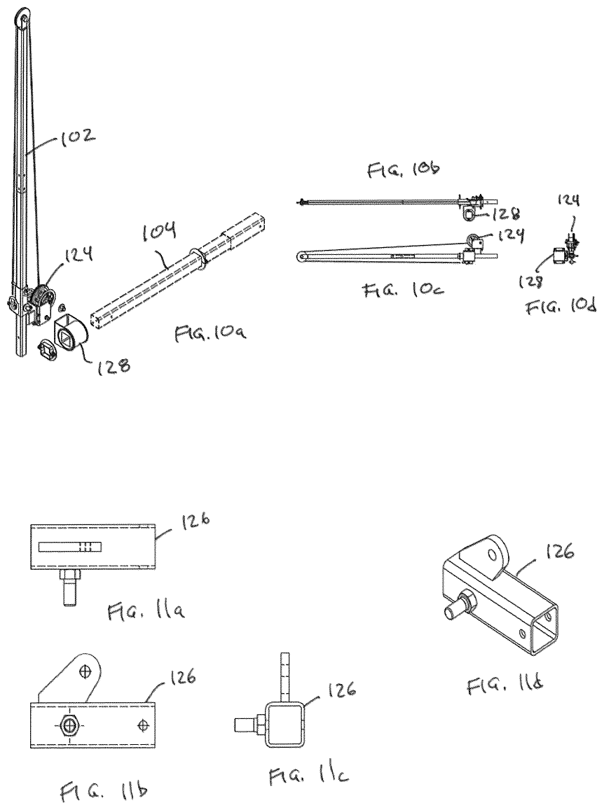

Turning now to FIG. 9, a further feature of the exemplary system 100 is illustrated. The slide 126 is provided with a pivot bracket 128 (shown in detail in FIG. 12a to 12d) which allows for axial rotation of the second mast segment 104. The pivot bracket 128 rotatably retains the second mast segment 104, allowing the second mast segment 104 to be axially rotated within the pivot bracket 128. This allows the box 118 to be rotated away from the railcar and thus helps reduce the risk of contact between the box 118 and the extensions 130 during rotation of the second mast segment 104 from horizontal to vertical orientation, and the box 118 can then be rotated back above the upper surface to allow resting of the box 118 on the upper surface as shown in FIG. 8f.

As can be seen, systems in accordance with the present invention are portable and mountable directly on a railcar (and optionally also adjacent rails by tensioning cables) and can therefore be deployed at any location where a railcar is located. It is not necessary to move the railcar adjacent a permanent or semi-permanent structure, but the system can instead be taken to where the railcar is located for temporary installation and then removed when the work on the railcar has been completed.

The foregoing is considered as illustrative only of the principles of the present invention. The scope of the claims should not be limited by the exemplary embodiments set forth in the foregoing but should be given the broadest interpretation consistent with the specification as a whole.

1. A portable fall protection system for use with a railcar, the railcar comprising an upper surface and first and second draw bars at opposite ends of the railcar, the railcar situated on rails, the system comprising:
first and second draw bar adapters removably attachable to the first and second draw bars, respectively;
first and second masts removably mountable on the first and second draw bar adapters, respectively, the first and second masts extending above the upper surface of the railcar when mounted on the first and second draw bar adapters; and
a cable configured for extension between upper ends of the first and second masts, the cable configured for receipt of a user connection member connecting the user to the cable to allow the user to walk along the upper surface of the railcar.

2. The system of claim 1, further comprising:
a winch on the first mast and a weight indicator on the second mast, the cable extending between the winch and the weight indicator through pulleys on top of each of the first and second masts, allowing tensioning of the cable.

3. The system of claim 1, further comprising:
at least one tensioning cable for removable connection between each of the first and second masts and the rails.

4. The system of claim 1, wherein:
each of the first and second masts comprise a plurality of sections configured for assembly on the railcar.

5. The system of claim 1, further comprising:
first and second bracket members, each of the first and second bracket members configured for securing to the first and second masts, respectively, and resting on the upper surface of the railcar.

6. The system of claim 5, further comprising:
a diagonal support arm adjacent each of the first and second bracket members to provide support between the first and second masts and the first and second bracket members.

7. The system of claim 1, wherein:
the first and second masts comprise first and second segments;
the first segments of the first and second masts vertically mountable on the first and second draw bar adapters, respectively; and
the first segments configured to raise and lower the second segments;
such that the second segments can be raised in horizontal orientation and then rotated to vertical allowing the cable to extend between upper ends of the second segments.

8. The system of claim 7, wherein:
each of the first and second draw bar adapters comprises an aperture configured for receiving a lower end of the second segment.

9. The system of claim 7, wherein:
each of the first segments comprises a winch for raising and lowering the second segment.

10. The system of claim 9, wherein:
each of the first segments is provided with a sliding member for rotatably retaining the second segment, the sliding member vertically displaceable by means of the winch.

11. The system of claim 8, wherein:
the upper ends of the second segments comprise the first and second bracket members;
the second segments are configured to rotate from horizontal to vertical to allow the first and second bracket members to clear the upper surface of the railcar during rotation; and
the first and second bracket members are configured to rest on the upper surface when the second segments are lowered into the apertures.

12. The system of claim 11, wherein:
the first and second bracket members are configured to rotate to a first position on the second segments so as to avoid contact with the upper surface of the railcar during rotation; and
the first and second bracket members are configured to rotate to a second position after the first and second bracket members have cleared the upper surface to enable the first and second bracket members to rest on the upper surface.

13. The system of claim 7, further comprising:
at least one tensioning cable for removable connection between each of the first segments and the rails.
